(19) United States
(12) Patent Application Publication
(10) Pub. No.: US 2020/0316904 A1
(43) Pub. Date: Oct. 8, 2020

(54) MULTILAYER STRUCTURE, PRODUCTION AND USE THEREOF

(71) Applicant: Covestro Deutschland AG, Leverkusen (DE)

(72) Inventors: Frauke Kühn, Köln (DE); Gregor Murlowski, Köln (DE); Norbert Eisen, Köln (DE)

(21) Appl. No.: 16/303,816

(22) PCT Filed: Jun. 1, 2017
(86) PCT No.: PCT/EP2017/063279

§ 371 Date: Nov. 21, 2018

(30) Foreign Application Priority Data
Jun. 7, 2016 (EP) 16173240.9
Jun. 17, 2016 (EP) 16175009.6

(51) Int. Cl. B32B 5/18; C08G 18/10; C08G 18/32; C08G 18/48; C08K 3/22; C08K 5/3475; B32B 9/04; B32B 27/06; B32B 27/40; B29C 67/24

(52) U.S. Cl. CPC B32B 5/18; B29K 2075/00; C08G 18/3206; C08G 18/4816; C08G 18/4845; C08K 3/22; C08K 5/3475; B32B 9/046; B32B 27/065; B32B 27/40; B29C 67/246; C08K 2003/2241; B32B 2307/302; B32B 2605/08; B32B 2439/00; B32B 2250/40; B32B 2266/0278; B32B 2307/71; C08G 18/10

(57) ABSTRACT

The invention relates to a multilayer structure comprising at least three layers and to a method for the production and use thereof.

The invention relates to a multilayer structure made of at least three layers, to a process for production thereof and to use thereof.

EP 0 629 498 A1 describes a multilayer structure made of various grades of acrylic-butadiene-styrene (ABS). Various properties of the layers can be adjusted (chemicals resistance, heat resistance, impact resistance, hardness and processability). The material must then be subjected to the thermoforming process; this greatly restricts geometric freedom and is very energy-intensive.

WO 2014/108067 A1 describes an insulation component made of an interior insulation foam surrounded by a seamless layer made of rigid polymer. The exterior layer is produced by RIM (reaction injection molding). The foam component here is fixed in the mold, the reaction mixture for the production of the exterior layer is injected, and the product is produced by the RIM process. The fabricated part can by way of example serve as door in a refrigerator. Various parts are brought together to form the fabricated part in a manner that requires no seams. Nothing is said about the optical properties at the surface or about the lightfastness of the components, this being particularly important when the fabricated part is used as external side of a refrigerator. There is also a lack of clarity as to how add-on parts such as handles, lights, etc. can be integrated into the fabricated part.

It was therefore an object of the present invention to provide a multilayer system, and also a process that is easy to carry out for the production of a multilayer system, where the multilayer system comprises a layer with good UV resistance and with only small quantities of volatile constituents and with low migration values in oil and water, and where this layer is optionally food-resistant.

Surprisingly, it has been found that glycol-crosslinked polyurethane elastomers achieve the object for an exterior layer of a multilayer structure if the polyether polyols and/or polyester polyols used have a functionality of at least 2 and the polyether polyols and/or polyester polyols used in the production of the NCO prepolymers used likewise have a functionality of at least 2.

The invention therefore provides a multilayer system made of at least three layers with the following layer sequence: (i) a first exterior layer (1), (ii) a middle core layer made of a rigid polyurethane foam with thermal conductivity λ≤24 mW/m*K in accordance with DIN 52616 at 24° C. and (iii) a second exterior hydrolysis-resistant polyurethane layer (2), characterized in that the polyurethane of the second exterior layer (2) can be produced from the reaction of the following components:

a polyol component consisting of
a) at least one polyol from the group consisting of polyether polyol, polyester polyol and a mixture thereof respectively with number-average molar mass from 1000 to 12 000 g/mol and number-average functionality of at least 2,
b) at least one glycolic chain extender having two hydroxy groups per molecule and molar mass from 62 to 499 g/mol,
c) at least one polyether polyol with number-average functionality from 3 to 6 and number-average molar mass from 200 to 900 g/mol,
(d) at least one catalyst,
e) at least one inorganic white pigment which is dispersible in the polyol a),
f) at least one triazole-class UV absorber which is soluble or dispersible in the polyol a),
g) optionally auxiliary and/or additional substances,

and an isocyanate component consisting of
h) an NCO prepolymer with at most 28% by weight NCO content, based on at least one polyisocyanate from the group consisting of methylenediphenyl 4,4′-diisocyanate (MDI), 2,2′-MDI, 2,4′-MDI, higher homologs of these, mixtures thereof, 4,4′-diisocyanatodicyclohexylmethane (HMDI), 2,4′-HMDI, higher homologs of these and mixtures thereof, and at least one polyol from the group consisting of polyether polyol, polyester polyol and mixtures thereof respectively with number-average molar mass from 150 to 12 000 g/mol and with number-average functionality of at least 2,

where, based on the entirety of components a), b), c), d) and h), the quantities used of the polyol a) are from 25 to 50% by weight, preferably from 30 to 40% by weight, the quantities used of the chain extenders b) are from 6 to 14% by weight, preferably from 8 to 12% by weight, the quantities used of the polyether polyol c) are from 2 to 10% by weight, the quantities used of the catalyst d) are from 0.05 to 0.5% by weight, preferably from 0.1 to 0.4% by weight, the quantities used of the inorganic white pigment e) are from 0.1 to 5% by weight, the quantities used of the UV absorbers f) are from 0.1 to 5% by weight, and the ratio of the NCO groups in the isocyanate component to the OH groups in the polyol component is from 0.9:1 to 1.2:1, and

where the TVOC (total volatile organic components) content of the polyurethane is below 3000 μg TÄ/Nm³ in accordance with DIN EN ISO 16000-9 after storage for 24 h at room temperature with air change rate 0.5 m³/h, temperature 23° C. and relative humidity 50%, and a ΔE of the polyurethane is smaller than 13 after irradiation for 500 h in accordance with DIN ISO 16474-2, part 2 xenon arc lamps, in accordance with method B (xenon arc lamp with window glass filters, intensity of irradiation 50 W/m² at from 300 to 400 nm, sample space temperature 38° C., black standard temperature 65° C. and relative humidity 50%),

and the polyurethane of the middle core layer can be produced from the reaction of the following components:
A) at least one polyol from the group consisting of polyether polyols, polyester polyols and polyester polyether polyols
B) aromatic polyisocyanates
C) physical blowing agents
D) water
E) optionally catalysts,
F) optionally auxiliary and/or additional substances,

where the polyurethane of the middle core layer is not chemically the same as the polyurethane of the second exterior layer (2).

The expression “chemically the same” means that the quantity and chemical structure of all of the reaction components of the middle core layer are the same as the quantity and chemical structure of all of the reaction components of the second exterior layer (2).

The first exterior layer (1) of the multilayer system can consist of various materials, but the material used—insofar as polyurethane is involved here—is not chemically the same as the polyurethane of the middle core layer.

The expression “chemically the same” means that the quantity and chemical structure of all of the reaction components of the middle core layer is the same as the quantity and chemical structure of all of the reaction components of the exterior layer (1).

The multilayer system made of at least three layers is what is known as a sandwich element.

Polyols used as component a) for the polyurethane of the second exterior layer (2) are particularly preferably those whose number-average molar mass is from 1000 to 8000 g/mol and whose number-average functionality is from 3 to 6.

Polyols particularly preferably used as polyol in component h) for the polyurethane of the second exterior layer (2) are those whose number-average molar mass is from 150 to 8000 g/mol and whose number-average functionality is from 3 to 6.

These polyols used as component a) and, respectively, as polyol in component h) are known to the person skilled in the art and are described in more detail by way of example in G. Oertel Kunststoffhandbuch [Plastics handbook], vol. 7, Carl Hanser Verlag, 3rd edn., Munich/Vienna 1993, pp. 57 to 75.

The polyether polyols can be produced in a known manner via alkoxylation of appropriate starter compounds, preferably with the use of ethylene oxide and/or propylene oxide as alkoxylating agents. Starters used are preferably hydroxylated compounds whose number-average functionality is at least 2. Examples of starter compounds that can be used are sorbitol, sucrose, pentaerythritol, glycerol, trimethylolpropane, propylene glycol, ethylene glycol, butylene glycol and water.

The polyester polyols are likewise produced in a known manner via polycondensation of polybasic carboxylic acids with appropriate hydroxy compounds, polycondensation of hydroxycarboxylic acids, polymerization of cyclic esters (lactones), polyaddition of carboxylic anhydrides with epoxides, or else reaction of acyl chlorides with alkali metal salts of hydroxyl compounds. The polyesters are preferably produced via polycondensation of polybasic carboxylic acids such as phthalic acid, isophthalic acid, terephthalic acid, fumaric acid, glutaric acid, adipic acid and succinic acid with suitable hydroxy compounds such as ethylene glycol, diethylene glycol, tetraethylene glycol, 1,2-propanediol, 1,4-butanediol, 1,6-hexanediol, glycerol and trimethylolpropane.

Glycolic chain extenders b) used for the polyurethane of the second exterior layer (2) are those having 2 hydroxy groups per molecule and molar mass from 62 to 499 g/mol. Mention may be made by way of example of ethylene glycol, butylene glycol, bis(hydroxyethyl)hydroquinone, bis(hydroxyethyl)bisphenol A, in particular ethylene glycol, 1,4-butanediol, 1,3-butanediol, and also 1,4-bis(2-hydroxyethyl)hydroquinone and any desired mixtures thereof.

Polyether polyols c) used are those with number-average functionality from 3 to 6 and number-average molar mass from 200 to 900 g/mol.

Catalysts d) that can be used for the production of the polyurethane elastomers of the second exterior layer (2) are any of the known catalysts and catalyst systems known in polyurethane chemistry. Reference is made in this connection by way of example to the abovementioned Kunststoffhandbuch [Plastics handbook], vol. 7 (Polyurethane), 3rd revised edition, Carl Hanser Verlag, Munich/Vienna 1993, pp. 104 ff. Particular mention may in particular be made of catalysts based on tertiary amines, for example diazobicyclo[2.2.2]octane, N-methylimidazole, dimethylaminopropylamine, 1,5-diazabicyclo[4.3.0]non-5-ene, and 1,8-diazabicyclo[5.4.0]undec-7-ene, and also organometallic compounds, for example dialkyltin alkylmercaptides, dialkyltin carboxylates, tin(II) carboxylates, zinc carboxylates, dialkoxytitanium carboxylates and titanium acetylacetonate.

Preference is given to use of titanium dioxide and zinc oxide as inorganic white pigment e). The quantity used of the pigment is from 0.1 to 5% by weight, based on the entirety of components a), b), c), d) and h). In a preferred embodiment, the white pigment can be used in the form of a color paste. In this case, the pigment is dispersed in a dispersion medium. Dispersion media used can preferably be the abovementioned polyols a).

Quantities used of the color pigments are preferably from 0.5 to 20% by weight, based on the entirety of components a), b), c), d) and h).

Compounds of the triazole class are preferably used as UV absorber f), an example being 2-(2H-benzotriazol-2-yl)-4,6-bis(1-methyl-1-phenylethyl)phenol. A quantity of from 0.5 to 8% by weight of these compounds are soluble or dispersible at room temperature in the polyol component. The term “triazoles” means heterocyclic aromatic compounds with the formula C₂H₃N₃ which comprise a five-atom ring having two carbon atoms and three nitrogen atoms.

Polyisocyanates that can be used in component h) for the polyurethane of the second exterior layer (2) are the MDI isomers known per se, mixtures of these, and higher homologs of these (pMDI), and also the hydrogenation products (HMDI) of the abovementioned isocyanates. Preference is given to 4,4′-MDI, 2,4′-MDI and 2,2′-MDI, in particular 4,4′-MDI and 4,4′-HMDI.

For the production of the polyurethanes, the abovementioned isocyanates are reacted in the form of NCO prepolymers h) with the polyols a) mentioned, the chain extenders b) and the polyether polyols c), the preferred NCO content of the NCO prepolymers used here being at most 28%, preferably from 14 to 28%, particularly preferably from 16 to 26%.

It is, of course, possible to use auxiliary and/or additional substances g) known from polyurethane chemistry, examples being surfactants, blowing agents, flame retardants, fillers, aging retarders, release agents, color pigments, biocides and antistatic agents. The quantities to be used of the auxiliary and/or additional substances depend on the particular intended use of the resultant polyurethane elastomers and, respectively, of the multilayer system produced therewith, and can easily be determined via appropriate preliminary experiments. These auxiliary and/or additional substances are likewise mentioned and described in the abovementioned Kunststoffhandbuch [Plastics handbook].

For TVOC (total volatile organic components) content determination, the test chamber concentration is stated in toluene equivalent per standard m³ [μg TÄ/Nm³], where the total area of the chromatogram is related to the toluene analytical window. The total area in the chromatogram between n-hexane and n-hexadecane is taken into account for the determination of the TVOC.

The polyols A) that are used for the middle core layer in the polyurethane can by way of example be polyether polyols, polyester polyols, or polyester polyether polyols, where these can be produced by methods described in the literature. Polyester polyols are produced by way of example via polycondensation of dicarboxylic acid equivalents (for example phthalic anhydride) and low-molar-mass polyols. Polyether polyols are produced via polyaddition (anionic or cationic) of epoxides onto starter molecules. Preferred epoxides are butylene 1,2-oxide, butylene 2,3-oxide, ethylene oxide and propylene oxide and mixtures thereof. Addition of epoxides onto polyester polyols leads to polyester polyether polyols. Catalysts known to the person skilled in the art can be used if necessary.

Polyisocyanates B) used can be any aromatic isocyanates known per se.

Examples of aromatic isocyanate component B) for the polyurethane of the middle core layer are aromatic polyisocyanates as described by way of example by W. Siefken in Justus Liebigs Annalen der Chemie, 562, pp. 75 to 136, for example those of the formula Q(NCO)n, where n is from 2 to 4, preferably 2, and Q is an aromatic hydrocarbon moiety having from 6 to 15, preferably from 8 to 13, carbon atoms; examples are polyisocyanates of the type described in DE-A 28 32 253, pp. 10 to 11.

Particular preference is generally given to the polyisocyanates that are easily obtainable industrially, e.g. tolylene 2,4- and 2,6-diisocyanate, and also any desired mixtures of these isomers (“TDI”), and polyphenyl polymethylene polyisocyanates, for example those produced via aniline-formaldehyde condensation and subsequent phosgenation (“crude MDI”).

A physical blowing agent C) is a component or a mixture of components, where these are volatile at room temperature and do not react with the isocyanate component. Substances preferably used as component C) are n-pentane, isopentane, cyclopentane and mixtures thereof, and fluorinated hydrocarbons.

Water is used as co-blowing agent D), the quantity thereof preferably being from 0.5 to 3.5% by weight, based on the polyol component A, particularly preferably from 1.5 to 2.5% by weight.

Compounds that can be used, if necessary, as catalysts E), are amine catalysts known to the person skilled in the art, based on tertiary amines for use in rigid polyurethane foam.

Substances that can be used concomitantly as auxiliary and/or additional substances F) in the middle core layer are paraffins, fatty alcohols, dimethylpolysiloxanes, and also pigments and dyes, and moreover stabilizers in respect of aging and weathering effects, plasticizers and fungistatic and bacteriostatic substances, and also fillers, for example barium sulfate, kieselguhr, carbon black or precipitated chalk.

Other examples of surface-active additional substances and foam stabilizers for optional concomitant use in the invention, and also cell regulators, reaction retarders, stabilizers, flame-retardant substances, dyes and fillers, and also fungistatic and bacteriostatic substances, and also details concerning mode of use and mode of action of these additional materials, are described in Kunststoff-Handbuch [Plastics handbook], vol. VII, ed. Vieweg and Hochtlen, Carl-Hanser-Verlag, Munich 1966, for example in pp. 121 to 205.

The rigid polyurethane (PUR) foams for the middle core layer can be produced by the single-stage process known from the literature, by reacting the reaction components with one another continuously or batchwise. The mixture of the components here is applied into or onto a suitable substrate or mold. Examples are found in G. Oertel (ed.) “Kunststoff-Handbuch” [Plastics handbook], Volume VII, Carl Hanser Verlag, 3rd edn., Munich 1993, pp. 267ff. and in K. Uhlig (ed.) “Polyurethan Taschenbuch” [Polyurethane handbook], Carl Hanser Verlag, 2nd edn., Vienna 2001, pp. 83-102.

The exterior layer consists of a plastic layer, lacquer layer, paper layer, glass layer, ceramic layer or metal layer.

The layer of plastic can by way of example be a film or a sheet made of ABS, of PCS, of polystyrene, or of modified polystyrene or polypropylene. The metal layer can by way of example be aluminum sheet, steel sheet, stainless steel or galvanized steel sheet.

The invention further provides a process for the production of the multilayer system of the invention, which has at least three layers, where
1) the second exterior layer (2) is produced by means of RIM processes (reaction injection molding) from the mixture of components a) to h) within a reaction time ≤5 sec.,
2) the second exterior layer (2) and the first exterior layer (1) are inserted into a foaming mold in a manner such that a cavity is formed between the two layers,
3) the cavity from step 2) is then foam-filled with the reaction mixture made of components A) to F) for the rigid polyurethane foam in a manner such that the middle core layer is formed, and
4) the product from step 3) is removed from the foaming mold.

Components a) to h) are mixed in what is known as a mixing head. The reaction time in step 1) is the time from discharge from the mixing head until hardening of the reaction mixture.

The sheet-like multilayer system can have an uncovered edge, or uncovered edges, thus rendering the cross section of the three layers visible. Between process steps 2) and 3), or after the removal (after step 4), a covering made of polyurethane can optionally be applied to the uncovered edge, or at least to one of the uncovered edges. The polyurethane of the covering can by way of example be the same as the polyurethane of the second exterior layer (2).

The present invention further provides the use of the multilayer systems of the invention for the production of automobile parts or of commercial-vehicle parts, of household equipment, of housings, of frame parts and of containers.

The invention will be explained in more detail with reference to the examples below.

### EXAMPLES

Starting Components for the Second Exterior Layer (2):
a) Polyols:

Polyol 1:

Polyether polyol, OH number 28, obtainable via addition of propylene oxide and ethylene oxide (in a ratio of 80:20) onto trimethylolpropane as starter having 90% of primary OH groups. Functionality: 3; Molar mass: 6000 g/mol;

Polyol 2:

Polyether polyol, OH number 35, obtainable via addition of propylene oxide and ethylene oxide (in a ratio of 80:20) onto trimethylolpropane as starter having 90% of primary OH groups. Functionality: 3, Molar mass: 4800 g/mol;
b) Ethylene glycol
c) Polyether polyol, OH number 550, functionality 3, molar mass 305 g/mol
d) Catalysts: Dabco T9 (tin octanoate)
   Fomrez UL32 (dioctyltin mercaptide)
   Dabco DMEA (dimethylethanolamine)
e) Titanium-dioxide-based white pastes: White Remap 10007 (about 50% by weight of TiO₂) Moltopren MP61005/1322 (about 60% by weight of TiO₂)
f) UV absorber: Tinuvin B75; mixture of antioxidant (Irganox 1135) and hindered amines (Tinuvin 765) and UV absorber (Tinuvin 571; 2-(2H-benzotriazol-2-yl)-6-dodecyl-4-methylphenol)
   Tinuvin 622; hindered amine (poly(N-beta-hydroxyethyl-2,2,6,6-tetramethyl-4-hydroxypiperidyl succinate))
   Milestab 234-PD (triazole); 2-(2H-benzotriazol-2-yl)-4,6-bis(1-methyl-1-phenylethyl)phenol
h) Prepolymer:

Prepolymer (PREP) with 23% NCO content, obtainable from 86.15% of 4,4′-diisocyanatodiphenylmethane having 33.5% NCO content and 13.85% of tripropylene glycol

Table 1 describes the components and quantities thereof for the production of the polyurethane of the second exterior layer (2).

TABLE 1

| | Example 1 | Example 2 | Example 3 | Example 4 |
|---|---|---|---|---|
| | (of the invention) | (comparative example) | (comparative example) | (comparative example) |
| Components | [% by weight] | [% by weight] | [% by weight] | [% by weight] |
| Polyol 1 | 31.7 | 75.53 | 38.92 | 38.92 |
| Polyol 2 | 31.7 | 0.00 | 38.92 | 38.92 |
| Ethylene glycol | 17.9 | 19.15 | 18.79 | 18.79 |
| Polyether polyol c) | 8.2 | | | |
| Moltopren-MP-61005/1322 | | 3.19 | 3.22 | 3.22 |
| White Remap 10007 | 6.1 | | | |
| Milestab 234-PD | 4.1 | | | |
| Tinuvin B75 | | 1.60 | | |
| Tinuvin 622: | | | | Not dispersible |
| | | | | and not soluble |
| Dabco T9 | | 0.27 | | |
| Dabco DMEA | | 0.27 | | |
| Fomrez UL32 | 0.26 | | 0.16 | 0.16 |
| Prepolymer PREP | 127.3 | 138.52 | 140.14 | 140.14 |

TABLE 1
ΔE after UV irradiation in accordance
with DIN ISO 16474-2, Method B

| | ΔE after 250 h | ΔE after 500 h |
|---|---|---|
| Example 1 | 8.1 | 10.5 |
| (of the invention) | | |
| Example 2 | | 23.0 |
| (comparative example) | | |
| Example 3 | | 42.1 |
| (comparative example) | | |
| Example 4 | | Not measurable |
| (comparative example) | | |
| HIPS* | | 9.4 |

*HIPS—High-impact polystyrene

Example 1 of the invention exhibited very little discoloring after 500 h of UV irradiation.

TABLE 3
Total migration in accordance with EU 10/2011, Annex V,
Chapter 3, Table 3, test no. OM1; triple determination

| | Residue | Residue | Residue |
|---|---|---|---|
| Solvent | [mg/dm²] | [mg/dm²] | [mg/dm²] |
| 3% by weight of acetic acid | 2.0 | 2.3 | 2.0 |
| 10% by volume of ethanol | 2.0 | 1.6 | 1.6 |

Total migration values measured on the second exterior layer (2) of the invention in testing in accordance with Regulation (EU) No. 10/2011 Annex V, Chapter 3, Table 3, Test no. OM1 in 3% by weight acetic acid and 10% by volume of ethanol were smaller than 10 mg/dm².

The values for λE (UV resistance) and for total migration are dependent only on the second exterior layer (2), and these values were therefore determined directly on the second exterior layer (2).

The combination of this second exterior layer (2) with a core layer made of conventional rigid polyurethane foam and an exterior layer gives a three-layer composite with good adhesion and with good mechanical stability, and with thermal conductivity λ<24 mW/m*K in accordance with DIN 52616 at 24° C., resulting from the rigid polyurethane foam layer.

1. A multilayer system made of at least three layers with the following layer sequence: (i) a first exterior layer (1), (ii) a middle core layer made of a rigid polyurethane foam with a thermal conductivity of λ≤24 mW/m*K in accordance with DIN 52616 at 24° C. and (iii) a second exterior hydrolysis-resistant polyurethane layer (2), wherein the polyurethane of the second exterior layer (2) can be produced from the reaction of the following components:
a polyol component consisting of:
a) at least one polyol selected from the group consisting of a polyether polyol, a polyester polyol and a mixture thereof respectively with a number-average molar mass from 1000 to 12 000 g/mol and a number-average functionality of at least 2,
b) at least one glycolic chain extender having two hydroxy groups per molecule and a molar mass from 62 to 499 g/mol,
c) at least one polyether polyol with a number-average functionality from 3 to 6 and a number-average molar mass from 200 to 900 g/mol,
(d) at least one catalyst,
e) at least one inorganic white pigment which is dispersible in the polyol a),
f) at least one triazole-class UV absorber which is soluble or dispersible in the polyol a),
g) optionally auxiliary and/or additional substances,
and an isocyanate component consisting of:
h) an NCO prepolymer with at most 28% by weight NCO content, based on at least one polyisocyanate selected from the group consisting of methylenediphenyl 4,4′-diisocyanate (MDI), 2,2′-MDI, 2,4′-MDI, higher homologs of these, mixtures thereof, 4,4′-diisocyanatodicyclohexylmethane (HMDI), 2,2′-HMDI, 2,4′-HMDI, higher homologs of these and mixtures thereof, and at least one polyol selected from the group consisting of polyether polyol, polyester polyol and mixtures thereof respectively with a number-average molar mass from 150 to 12 000 g/mol and with a number-average functionality of at least 2,
wherein, based on the entirety of components a), b), c), d) and h), the quantities used of the polyol a) are from 25 to 50% by weight, the quantities used of the chain extenders b) are from 6 to 14% by weight, the quantities used of the polyether polyol c) are from 2 to 10% by weight, the quantities used of the catalyst d) are from 0.05 to 0.5% by weight, the quantities used of the inorganic white pigment e) are from 0.1 to 5% by weight, the quantities used of the UV absorbers f) are from 0.1 to 5% by weight, and the ratio of the NCO groups in the isocyanate component to the OH groups in the polyol component is from 0.9:1 to 1.2:1, and
wherein the TVOC (total volatile organic components) content of the polyurethane is below 3000 μg TÄ/Nm³ in accordance with DIN EN ISO 16000-9 after storage for 24 h at room temperature with air change rate 0.5 m³/h, temperature 23° C. and relative humidity 50%, and a ΔE of the polyurethane is smaller than 13 after irradiation for 500 h in accordance with DIN ISO 16474-2, part 2 xenon arc lamps, in accordance with method B (xenon arc lamp with window glass filters, intensity of irradiation 50 W/m² at from 300 to 400 nm, sample space temperature 38° C., black standard temperature 65° C. and relative humidity 50%),
and the polyurethane of the middle core layer can be produced from the reaction of the following components:
A) at least one polyol selected from the group consisting of polyether polyols, polyester polyols and polyester polyether polyols
B) aromatic polyisocyanates
C) physical blowing agents
D) water
E) optionally catalysts,
F) optionally auxiliary and/or additional substances,
wherein the polyurethane of the middle core layer is not chemically the same as the polyurethane of the second exterior layer (2).

2. A process for the production of the multilayer system as claimed in claim 1, which has at least three layers, wherein
1) the second exterior layer (2) is produced by means of RIM processes (reaction injection molding) from the mixture of components a) to h) within a reaction time ≤5 sec.,
2) the second exterior layer (2) and the first exterior layer (1) are inserted into a foaming mold in a manner such that a cavity is formed between the two layers,
3) the cavity from step 2) is then foam-filled with the reaction mixture made of components A) to F) for the rigid polyurethane foam in a manner such that the middle core layer is formed, and
4) the product from step 3) is removed from the foaming mold.

3. A method of using the multilayer system as claimed in claim 1 comprising producing a product selected from the group consisting of automobile parts or commercial-vehicle parts, household equipment, housings, frame parts and containers.
